(19) United States
(12) Patent Application Publication
(10) Pub. No.: US 2012/0100276 A1
(43) Pub. Date: Apr. 26, 2012

(54) FOOD EMULSIONS

(76) Inventors: Emilien Louis Joseph Esteve, Baulmes (CH); Clive Richard Thomas Norton, Reading (GB)

(21) Appl. No.: 13/377,337

(22) PCT Filed: Jul. 5, 2010
(86) PCT No.: PCT/GB10/01287

§ 371 Date: Dec. 9, 2011

(30) Foreign Application Priority Data
Jul. 6, 2009 (GB) 0911700.3

(51) Int. Cl. A23D 7/00; A21D 13/08; A23D 7/06

(52) U.S. Cl. 426/549; 426/603; 426/604; 426/506

(57) ABSTRACT

A savoury water-in-oil food emulsion comprises a fat phase and an aqueous phase. The aqueous phase comprises at least 50% dissolved solids. Also provided are a food composition comprising the emulsion, and a method of preparing the emulsion.

The present invention relates to emulsions. In particular, it relates to emulsions for use in food compositions.

Fat-based savoury food products are well known in the art. In particular, fat-based spreads such as butter and margarine consist of water-in-oil emulsions in which discrete aqueous droplets are suspended in a bulk fat phase. Such emulsions also form the basis for many other savoury spreads, fillings, coatings and other food products.

The use of an emulsion structure offers a number of advantages. In particular, the discrete water droplets provide bulk to the product without increasing fat content. Furthermore, many such compositions are readily spreadable, providing ease of use.

Nevertheless, there remain a number of problems associated with such products. Most notably, the products are generally susceptible to bacterial degradation, and must be refrigerated during storage. Undesirable changes to the texture of the product can also occur over time.

According to a first aspect of the invention, there is provided a savoury water-in-oil food emulsion comprising a fat phase and an aqueous phase, wherein the aqueous phase comprises at least 50% dissolved solids.

Savoury water-in-oil emulsions having dissolved solids in the aqueous phase are known in the art. For example, GB 1 163 949 and U.S. Pat. No. 4,536,408 both disclose such emulsions. However, neither document clearly and unambiguously discloses the formation of savoury emulsions having at least 50% dissolved solids in the aqueous phase. In GB 1 163 949 no distinction is made between those solids which are dispersed, and those which dissolve, or between those located in the fat phase and those in the aqueous phase. In U.S. Pat. No. 4,536,408, the solids contents disclosed are less than 50%.

In some further embodiments, the aqueous phase comprises at least 60% dissolved solids, at least 70% dissolved solids, at least 75% or at least 80% dissolved solids.

The inventors have surprisingly found that increasing the dissolved solids content of the aqueous phase provides stability to the emulsion structure. Without wishing to be bound by theory, this may be a result of increased viscosity, decreased water activity, or both.

In some further embodiments, the dissolved solids comprise bulk sweetener.

In some further embodiments, the dissolved solids form a saturated solution in the aqueous phase.

In some embodiments, the emulsion has a water activity (a_{w}) of less than 0.8. In some further embodiments, the food emulsion has a water activity of less than 0.75, less than 0.73, less than 0.71, less than 0.65, or less than 0.60.

It has surprisingly been found by the present inventors that a savoury food emulsion having enhanced stability to bacterial degradation can be formed by decreasing the water activity of the emulsion. Thus, for example, it is possible to form a savoury food emulsion which is stable at room temperature for up to 9 to 12 months, and which therefore has no need of refrigeration.

In some embodiments, the emulsion further comprises a particulate flavouring component.

It will be understood that, as used herein, ‘particulate flavouring component’ is intended to refer to a flavouring component which is present in the emulsion in the form of discrete particles, and is not dissolved in either the fat phase or the aqueous phase.

In some embodiments, the particulate flavouring component is distributed throughout the fat phase (for example, homogeneously). Without wishing to be bound by theory, it is believed that location of the particulate flavouring component in the bulk fat phase allows the flavour of the particulate flavouring component to be experienced by a consumer immediately upon consumption of the emulsion, without first requiring breakdown of the emulsion structure. This increases the perception of the flavour of the particulate flavouring material, reducing the quantity of flavouring material required to obtain a given level of flavour, and allowing any natural flavour associated with the emulsion to be more easily masked. Furthermore, the presence of the particulate flavouring material is believed to provide some slight disruption of the stabilising structure created by the fat phase. This results in the emulsion having an improved texture, and provides better release of the flavour from the emulsion into the oral cavity on consumption.

In some further embodiments, the particulate flavouring component comprises solid particles of flavouring material. Such particles may be in the form of flakes, powder, granules, crystals, or other suitable solid particles. Suitable flavouring materials are known in the art. In some still further embodiments, the particulate flavouring component comprises a powdered flavouring material. An exemplary powdered flavouring material is finely ground sodium chloride.

In some further embodiments, the particulate flavouring component comprises discrete encapsulated regions of flavouring material. The flavouring material within the encapsulated regions may be, for example, solid or liquid.

In some embodiments, the aqueous phase comprises a water activity depressant. Such substances are known in the art, and include glycerol and propylene glycol.

In some embodiments, the emulsion comprises at least 0.10% emulsifier. In some further embodiments, the emulsion comprises at least 0.20%, at least 0.40%, at least 0.60%, at least 0.70%, at least 0.80%, at least 0.90%, or at least 0.95% emulsifier. In some still further embodiments, the emulsion has a flavour other than blue cheese flavour.

In some embodiments, the emulsion comprises at least 0.50% emulsifier.

The inventors have surprisingly found that such levels of emulsifier allow the use of high levels of dissolved bulk sweetener in the aqueous phase without significantly increasing the perceived sweetness of the emulsion. Without wishing to be bound by theory, it is believed that the emulsifier stabilises the emulsion to such a degree that the emulsion structure is only slowly broken down upon consumption. Thus, the contents of the discrete aqueous phase droplets, including any dissolved bulk sweetener, are not readily released into the oral cavity.

In some further embodiments, the emulsion comprises less than 2.00% emulsifier, or less than 1.50% emulsifier.

In some further embodiments, the emulsion comprises at least two emulsifiers, and the total emulsifier content is at least 0.10%.

In some embodiments, the emulsion comprises polyglycerol polyricinoleate (PGPR) and distilled monoglycerides. In some further embodiments, the emulsion has a flavour other than blue cheese flavour.

The inventors have surprisingly found that the combination of PGPR and distilled monoglycerides provides a stable emulsion having a superior taste, texture and mouthfeel.

In some further embodiments, the ratio of PGPR to distilled monoglycerides is between 2:1 and 1:2, between 3:2 and 2:3, or between 5:4 and 4:5. In some still further embodiments, the ratio of PGPR to distilled monoglycerides is substantially 1:1.

In some embodiments, the emulsion is sugar-free.

In some embodiments, the fat phase forms less than 99% of the emulsion, less than 50% of the emulsion, less than 30% of the emulsion, less than 20%, or less than 15% of the emulsion. In some embodiments, the fat phase forms at least 5% of the emulsion, at least 8%, or at least 10% of the emulsion. In some embodiments, the fat phase forms from 10 to 13% of the emulsion.

In some embodiments, the majority of the emulsion may be formed by the aqueous phase.

In some embodiments, the aqueous phase comprises a bulk sweetener. Examples of bulk sweeteners include sugars and sugar-free bulk sweeteners. In some embodiments, the bulk sweetener may form at least 60% of the emulsion. In some embodiments, the bulk sweetener may form at least 70%, at least 80% or at least 85% of the emulsion.

In some embodiments, the fat phase comprises a first fat having a first melting point and a second fat having a second melting point lower than the first melting point. In some embodiments, the first melting point may be greater than 18° C. The first and second fats may be selected so that, for example, the second fat is liquid at a serving temperature (such as for example at room temperature), whilst the first fat is solid at the serving temperature. The liquid second fat enables the emulsion to flow (thereby allowing deposition of the emulsion within a product, for example), and may provide a creamy mouthfeel and texture to the consumer. The solid first fat provides structure and stability.

In some embodiments, the first fat may exist in more than one crystal form, and may be present in the emulsion in substantially a single crystal form. The first fat may be a tempering fat. Examples of tempering fats include cocoa butter (which can exist in at least six different crystal forms), and in particular the single crystal form may be the Form V (or β2) crystal form of cocoa butter. The selection of a particular crystal form may contribute to the structural stabilisation effect described above, by providing a kinetic or thermodynamic barrier to disruption of the structure.

In some embodiments, the second fat may be a non-tempering fat. Examples of non-tempering fats include palm oil, palm kernel oil, butterfat, cocoa butter replacers and cocoa butter substitutes. Typically, cocoa butter replacers are hydrogenated, fractionated fat blends from soybean oil, rapeseed oil, palm oil, cottonseed oil, and/or sunflower oil, or other similar fats. Typically, cocoa butter substitutes are high lauric acid-containing fats, such as hydrogenated, fractionated fatblends from coconut and/or palm kernel oil, or other similar fats.

In some embodiments, the first (crystalline) fat may be cocoa butter (which can exist in at least six different crystal forms), and in particular the single crystal form may be the Form V (or β2) crystal form. In some embodiments, the second fat may be non-crystalline, or may exist in the solid state in only a single crystal form (i.e. the second fat is non-temperable). In some embodiments, the second fat is palm oil.

In some embodiments, the ratio of the first fat to the second fat is between 3:1 and 1:3. In some further embodiments, the ratio is between 2:1 and 1:2.

In some embodiments, the first fat forms less than 20%, less than 15%, or less than 10% of the emulsion. In some embodiments, the first fat forms at least 1% or at least 5% of the emulsion.

In some embodiments, the emulsion comprises one or more flavourings. The flavourings may be associated individually with sweet, sour, salty, savoury or umami flavours, provided that the flavour profile of the emulsion as a whole is savoury. In some embodiments, the emulsion comprises one or more savoury flavourings.

In some embodiments, at least one of the fat phase and the aqueous phase comprises a flavouring. In further embodiments, the confectionery emulsion further comprises a first flavouring in the fat phase and a second flavouring in the aqueous phase. In some embodiments, the first flavouring and the second flavouring provide different flavours.

According to a second aspect of the invention, there is provided a food composition comprising an emulsion according to the first aspect of the invention.

In some embodiments, the food composition is a biscuit composition.

In some embodiments, the emulsion may be incorporated within the food composition as a discrete region, such as for example as a filling. In alternative embodiments, the emulsion may be mixed with other ingredients, and/or distributed homogeneously throughout the food composition.

In some embodiments the food composition comprises an outer shell or coating and an inner filling comprising the emulsion. In some further embodiments, the inner filling consists substantially of the emulsion.

In some further embodiments, the outer shell comprises two or more biscuit layers, and the inner filling comprises a layer of filling material disposed between the biscuit layers.

According to a third aspect of the invention, there is provided a method for preparing a savoury water-in-oil food emulsion, comprising providing a first liquid for forming a fat phase, providing a second liquid for forming an aqueous phase, and mixing the first and second liquids to form a water-in-oil emulsion, wherein the second liquid comprises at least 50% dissolved solids.

In some embodiments, the second liquid comprises at least 60% dissolved solids, at least 70%, at least 75% or at least 80% dissolved solids.

In some embodiments, the dissolved solids comprise bulk sweetener.

In some embodiments, the dissolved solids form a saturated solution in the second liquid.

In some embodiments, the emulsion has a water activity (a_{w}) of less than 0.8, and the second liquid has a water activity (a_{w}) of less than 0.80. In some further embodiments, the second liquid has a water activity of less than 0.75, less than 0.73, less than 0.71, less than 0.65, or less than 0.60.

In some further embodiments, the second liquid comprises a water activity depressant. Such substances are known in the art, and include glycerol and propylene glycol.

In some embodiments, the method further comprises adding a particulate flavouring material to at least one of the first liquid, the second liquid, and the water-in-oil emulsion.

In some embodiments, the particulate flavouring material is added to the emulsion. It will be understood that, in general, addition of particles to the emulsion will cause those particles to be located in the continuous fat phase.

Without wishing to be bound by theory, it is believed that the presence of a particulate flavouring material throughout the emulsion provides some slight disruption of the stabilising structure created by the fat phase. This results in the emulsion having an improved texture, and provides better release of flavour from the emulsion into the oral cavity on consumption.

In some further embodiments, the method further comprises cooling the water-in-oil emulsion and the particulate flavouring material is added to the emulsion during or after the cooling step. Again, this is believed to produce a slight destabilisation of the emulsion structure, producing an improved texture and flavour release.

In some embodiments, the first liquid comprises emulsifier.

In some further embodiments, the emulsifier comprises polyglycerol polyricinoleate (PGPR) and distilled monoglycerides. In some still further embodiments, the ratio of PGPR to distilled monoglycerides is between 2:1 and 1:2, between 3:2 and 2:3, or between 5:4 and 4:5. In some still further embodiments, the ratio of PGPR to distilled monoglycerides is substantially 1:1.

In some embodiments, the temperature of the second liquid on mixing with the first liquid is no more than 50° C.

In some embodiments, mixing the first and second liquids to form a water-in-oil emulsion comprises adding the second liquid to the first liquid in a mixer. Suitable mixers include planetary-action mixers available from Hobart UK, 51 The Bourne, Southgate, London N14 6RT, UK. Other mixing techniques will be readily apparent to the skilled man.

In some embodiments, the method further comprises cooling the water-in-oil emulsion, In some further embodiments, the first liquid comprises a first fat having a first melting point and a second fat having a second melting point, and cooling the water-in-oil emulsion comprises cooling the emulsion to a temperature between the first and second melting points.

In some embodiments, the first melting point is greater than 18° C.

In some embodiments, the first fat is a crystalline fat. In some embodiments, the first fat can exist in more than one crystal form and, subsequent to cooling the emulsion to a temperature lower than the first melting point but greater than or equal to the second melting point, the first fat may be present substantially in a single crystal form. In some further embodiments, cooling the emulsion to a temperature lower than the first melting point but greater than or equal to the second melting point may comprise causing the first fat to adopt preferentially a single crystal form. Alternatively or additionally, the method may further comprise processing the cooled emulsion to cause the first fat to adopt preferentially a single crystal form.

Without wishing to be bound by theory, it is believed that cooling of the first fat in the emulsion to below its melting point allows the fat crystals formed to stabilise the emulsion. One mechanism might involve the formation of a network of fat crystals around incorporated aqueous droplets, in a manner analogous to a Pickering emulsion. The selection of a temperature equal to or above the melting point of the second fat causes the second fat to remain liquid, allowing continued working or deposition of the emulsion, whilst the first fat is crystallised.

In some embodiments, cooling the emulsion comprises mechanically working the emulsion as it cools. In further embodiments, working the emulsion comprises working the emulsion on a slab, such as for example a marble slab.

It will be understood that, in some embodiments, cooling the emulsion to a temperature lower than the first melting point but greater than or equal to the second melting point comprises a cessation of cooling (which may be temporary) when such a temperature is achieved. In some embodiments, the method further comprises processing of the emulsion at such a temperature. For example, upon cooling to a temperature lower than the first melting point but greater than or equal to the second melting point, the emulsion may be deposited into a shell, mixed with other ingredients, or processed in any other manner apparent to the skilled man.

In some embodiments, mixing the first and second liquids to form a water-in-oil emulsion comprises adding the second liquid to the first liquid with mixing whilst cooling the mixture.

The following comments and embodiments apply to all aspects of the invention, insofar as they are compatible with the statements given above.

The invention relates to savoury emulsions. It will be understood that such emulsions have a flavour which is savoury, as opposed to sweet in nature. In particular, such emulsions have a flavour which is not predominantly sweet, or which a majority of trained testers rate as ‘savoury’ rather than ‘sweet’. In some embodiments, the emulsions of the invention exclude confectionery emulsions, such as for example confectionery fillings.

In some embodiments, the aqueous phase of the emulsion, or (in the case of aspects relating to methods for preparing an emulsion, the second liquid for forming an aqueous phase) comprises a bulk sweetener.

Exemplary bulk sweeteners include sugars and non-sugar sweeteners. Exemplary sugars include sucrose, glucose, fructose, maltose, high maltose glucose syrup, glucose fructose syrup and corn syrup. Exemplary non-sugar sweeteners include polydextrose, inulin and sugar alcohols (including maltitol, erythritol, xylitol, mannitol, glycol, glycerol, arabitol, threitol, ribitol, sorbitol, dulcitol, iditol and hydrogenated isomaltulose).

The inventors have surprisingly found that it is possible to create water-in-oil emulsions in which the aqueous phase comprises significant quantities of bulk sweetener, whilst the emulsion as a whole retains a savoury flavour. It is counterintuitive to consider addition of bulk sweetener to an emulsion intended to have a strongly savoury or non-sweet flavour.

Without wishing to be bound by theory, it is believed that the methods and products described herein stabilise the water-in-oil emulsion structure to such a degree that that the bulk sweetener is not readily released into the mouth of the consumer on consumption. Thus, the bulk sweetener does not contribute to any significantly sweet taste, and does not overwhelm the main savoury taste associated with the emulsion. It is believed that the presence of bulk sweetener in the aqueous phase contributes to a reduction in the water activity thereof, thereby promoting microbial stability. The bulk sweetener may also contribute to the physical stability of the emulsion, such as for example by increasing the viscosity of the aqueous phase.

In some embodiments, the emulsion has a flavour selected from cheese, dairy, meat, fish, spice, herbs, fruits, vegetables, nuts, sauces & spreads, bakery products, pet foods, beverages, and other savoury flavours.

Suitable cheese flavours include soft cheese flavours, semi-soft cheese flavours, and hard cheese flavours. Exemplary soft cheese flavours include boursault, brie, brillat-savarin, brinza, camembert, caprice des dieux, carré de rest, chaource, coulommiers, epoisses de bourgogne, explorateur, feta, handkäse, harz, humboldt fog, kochkäse, liederkranz, livarot, manouri, maroilles, paglietta, pont-l'eveque, reblochon, ricotta salata, robiola piemonte, robiola lombardia, schloss, saint andré, saint marcellin, stracchino and telleme. Exemplary semi-soft cheese flavours include asadero, bierkäse, bel paese, caciocavallo, casero, chaubier, corsu vecchio, esrom, fiore sardo, gouda, halloumi, jack, laguiole, lappi, limburger, morbier, mozzarella, münster, ossauiraty, port salut, provolone, saint-paulin, samso, scamorza, taleggio, tilsit, tomme, tybo and vacherin. Exemplary hard cheese flavours include appenzeller, asiago, beaufort, caciotta, caerphilly, cantal, cheddar, cheshire, chevre, danbo, derby, edam, emmental, fontina, gamonedo, gjetost, gloucester, gruyere, idiazabal, jarlsberg, kashkaval, lancashire, leyden, mahón, manchego, parmesan, raclette, saint nectaire, tête de moine, vasterboten and wensleydale.

Suitable meat flavours include beef, lamb, chicken, pork, venison, salami, sausage, ham, bacon, pork, egg, paté, kidney, liver, snails and frogs.

Suitable fish flavours include cod, herring, salmon, smoked salmon, prawn, shrimp, crab, squid, octopus and shellfish.

Suitable spice flavours include curry (such as for example korma, madras, jalfrezi, rogan josh, vindaloo), chilli, pepper, ginger, clove, cinnamon and nutmeg.

Suitable herb flavours include thyme, mint, basil, rosemary, chives, lavender, rose and stuffing.

Suitable fruit flavours include apple, banana, citrus (such as for example orange, lemon, lime, grapefruit), tropical fruits (such as for example pineapple, passionfruit, guava, melon, watermelon), berries (such as for example blackberry, raspberry, blackcurrant, redcurrant, gooseberry), grape, plum, apricot, nectarine, tomato, avocado, courgette, pumpkin, eggplant, strawberries and figs.

Suitable vegetable flavours include potato, garlic, broccoli, leek, cabbage, lettuce, radish, onion, parsnip, peas, beans, carrots, cabbage, brussels sprouts, seaweed and beets.

Suitable nut flavours include peanut, hazelnut, walnut, pistachio, almond, marzipan, praline, pine seeds, dates and coconut.

Suitable sauces & spreads flavours include tomato sauce, brown sauce, mayonnaise, chutney, pickle, mustard, horseradish, houmous, tsadziki, oils (such as for example olive oil, walnut oil, sesame oil, peanut oil), vinegar, vinaigrette, thousand island dressing, barbecue sauce, guacamole, cajun sauce, peri peri sauce, ranch dressing, gravy, OXO (TM), yeast extract (such as for example MARMITE (TM)), malt, soy sauce, worcester sauce, oyster sauce and hoi-sin sauce.

Suitable bakery product flavours include biscuit cream fillings, pastry, pastries, bread and pizza.

Suitable petfood flavours include rabbit, beef, fish, rind, scratchings, smoke, digest, meal, fat and cream.

Suitable beverage flavours include beer, cider, stout, whiskey, gin, brandy, cola, coffee, tea, wine, sherry, port, snakebite & black, irish cream (such as for example BAILEYS (TM)), malt and barley.

Suitable other savoury flavours include cigarette, cigar, tobacco, toothpaste, mushrooms & other fungi, truffle and lipstick.

In some embodiments, the emulsion has a flavour other than blue cheese flavour.

All references to percentages of ingredients refer to percentages by weight.

In some embodiments, the emulsion comprises a water-in-oil (W/O) emulsion. Such an emulsion may be, for example, a water-in-oil (W/O) emulsion, an oil-in-water-in-oil (O/W/O) emulsion, or a water-in-oil-in-water (W/O/W) emulsion. In the case of an oil-in-water-in-oil (O/W/O) emulsion, references to an aqueous phase will be understood to include the oil-in-water (O/W) phase, and references to the fat phase will be understood to refer to the bulk fat phase. In the case of a water-in-oil-in-water emulsion, references to the aqueous phase will be understood to refer to the discrete (innermost) water phase.

The aqueous phase and/or second liquid may comprise other ingredients as appropriate. For example, the aqueous phase and/or second liquid may include preservatives, fibres (such as for example inulin), gelling agents (such as for example carrageenan, agar, starch or gelatine), flavourings (including food acids) and/or colourings.

Suitable preservatives include acetic acid, benzoic acid, sorbic acid, propionic acid, sodium or potassium salts of these acids, and sodium and potassium nitrites and sulfites.

Except as otherwise specified, the emulsifier used in aspects of the present invention may be any suitable emulsifier having an LB (hydrophilic-lipophilic balance) value below 7. Suitable emulsifiers include those approved for use in chocolate and known to the skilled man. Examples of suitable emulsifiers include lecithins; alginic acid; sodium alginate; potassium alginate; ammonium alginate; calcium alginate; propan-1,2-diol alginate; agar; carrageenan; locust bean gum; guar gum; tragacanth; gum arabic; xanthan gum; glycerol; polysorbate 20 (sold commercially as TWEEN 20); polysorbate 80 (TWEEN 80); polysorbate 40 (TWEEN 40); polysorbate 60 (TWEEN 60); polysorbate 65 (TWEEN 65); pectin; amidated pectin; ammonium phosphatides; methylcellulose; hydroxypropylcellulose; hydroxypropylmethylcellulose; ethylmethylcellulose; sodium, potassium and calcium salts of fatty acids; glyceryl monostearate; acetic acid esters; lactic acid esters; citric acid esters; tartaric acid esters; mono and diacetyltartaric acid esters; sucrose esters of fatty acids; sucroglycerides; polyglycerol esters of fatty acids; polyglycerol polyricinoleate; propan-1,2-diol esters of fatty acids; sodium stearoyl-2 lactate; calcium stearoyl-2 lactate; sorbitan monostearate; sorbitan tristearate; sorbitan monolaurate; sorbitan monooleate; sorbitan monopalmitate; and other mono- or diglycerides.

As used herein, the term ‘tempering fat’ has the standard meaning in the art, being used to refer to a fat having more than one crystal form having different thermodynamic or kinetic stabilities. As used herein, the term ‘tempering’ (when used as a verb) has the standard meaning in the art, being used to refer to a process whereby a tempering fat is preferentially crystallised into one of its crystal forms.

The emulsions of the present invention may have different textures, such as for example those of solids, pastes, gels, or liquids. In particular, it should be understood that, in aspects of the invention relating to methods for preparing emulsions, the use of first and second liquids does not preclude either component from undergoing a phase change (for example, solidification or gelation) subsequent to formation of the initial emulsion. For example, in some embodiments, the first liquid comprises or consists essentially of a fat which is solid at room temperature, and providing the first liquid comprises providing the first liquid at a temperature greater than the melting point of the fat. Similarly, in some embodiments, the second liquid comprises a gelling agent, such that t

Embodiment of aspects of the present invention will now be described by way of example.

### Example 1

Dairy-free cheese emulsion

Palm oil (48.0 g), deodorised cocoa butter (71.0 g), polyglycerol polyricinoleate (PGPR) (3.50 g), and distilled monoglycerides (3.50 g) were mixed and heated to 60° C. to form a fat phase. Separately, high maltose glucose syrup (614.0 g) and glucose fructose syrup (260.0 g) were mixed and heated to 40° C., and butyric acid (0.4 g) was added, to form an aqueous phase having a water activity (a_{w}) of 0.73 and a dissolved solids content of 74%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 5 minutes. Cooling water from a bath at 20° C. was then circulated through the jacket of the mixing bowl, and mixing was continued for 5-10 minutes until the temperature of the mixture had reached 25° C. At this point, both mixing and cooling were halted, and the mixture was deposited into sterilised containers.

### Example 2

Tomato & herb flavour emulsion

Palm oil (80.0 g), deodorised cocoa butter (120.0 g), polyglyceryl polyricinoleate (PGPR) (10.00 g), and distilled monoglycerides (10.00 g) were mixed and heated to 55° C. to form a fat phase. Separately, high maltose glucose syrup (1270.0 g) and glucose fructose syrup (440.0 g) were mixed and heated to 35 ° C., to form an aqueous phase having a water activity (a_{w}) of 0.72 and a dissolved solids content of 74%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 10 minutes, until the mixture had cooled to 28° C. Tomato powder (60.0 g), finely ground sodium chloride (5.0 g), and parsley flakes (5.0 g) were then added gradually with mixing. Once all of the particulate ingredients had been added, mixing was stopped and the bowl edges were scraped to ensure that all particles were fully incorporated.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers.

### Example 3

Bacon flavour emulsion

Palm oil (80.0 g), deodorised cocoa butter (120.0 g), polyglyceryl polyricinoleate (PGPR) (10.00 g), and distilled monoglycerides (10.00 g) were mixed and heated to 55° C. to form a fat phase. Separately, high maltose glucose syrup (1270.0 g) and glucose fructose syrup (426.0 g) were mixed and heated to 35 ° C., to form an aqueous phase having a water activity (a_{w}) of 0.72 and a dissolved solids content of 74%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 10 minutes, until the mixture had cooled to 28° C. Bacon flavour bits (40.0 g), finely ground sodium chloride (2.0 g), smoked paprika (0.2 g), and onion powder (40.0 g) were then added gradually with mixing. Once all of the particulate ingredients had been added, mixing was stopped and the bowl edges were scraped to ensure that all particles were fully incorporated.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers.

### Example 4

Spicy flavour emulsion

Palm oil (200.0 g), polyglyceryl polyricinoleate (PGPR) (10.00 g), and distilled monoglycerides (10.00 g) were mixed and heated to 55° C. to form a fat phase. Separately, high maltose glucose syrup (1270.0 g), acetic acid (2.0 g), and glucose fructose syrup (466.0 g) were mixed and heated to 35° C., to form an aqueous phase having a water activity (a_{w}) of 0.73 and a dissolved solids content of 74%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 10 minutes, until the mixture had cooled to 28° C. Mustard seed (40.0 g), finely ground sodium chloride (2.0 g), and smoked paprika (0.2 g) were then added gradually with mixing. Once all of the particulate ingredients had been added, mixing was stopped and the bowl edges were scraped to ensure that all particles were fully incorporated.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers,

### Example 5

Tea flavour emulsion

Palm oil (200.0 g), polyglyceryl polyricinoleate (PGPR) (10.00 g), and distilled monoglycerides (10.00 g) were mixed and heated to 55° C. to form a fat phase. Separately, high maltose glucose syrup (1270.0 g), black tea extract (6.0 g) and glucose fructose syrup (504.0 g) were mixed and heated to 35° C., to form an aqueous phase having a water activity (a_{w}) of 0.78 and a dissolved solids content of 75%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers.

### Example 6

Mushroom flavour emulsion

Palm oil (80.0 g), deodorised cocoa butter (120.0 g), mushroom flavouring (4.0 g), polyglyceryl polyricinoleate (PGPR) (10.00 g), and distilled monoglycerides (10.00 g) were mixed and heated to 55° C. to form a fat phase. Separately, maltitol syrup was heated to 35° C., to form an aqueous phase having a water activity (a_{w}) of 0.73 and a dissolved solids content of 74%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 5-10 minutes, until the mixture had cooled to 28° C. Finely ground sodium chloride (2.0 g) was then added gradually with mixing. Once all of the particulate ingredients had been added, mixing was stopped and the bowl edges were scraped to ensure that all particles were fully incorporated.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers.

### Example 7

Chicken flavour emulsion

Palm oil (80.0 g), deodorised cocoa butter (120.0 g), polyglyceryl polyricinoleate (PGPR) (10.00 g), and distilled monoglycerides (10.00 g) were mixed and heated to 55° C. to form a fat phase. Separately, high maltose glucose syrup (1100.0 g), glucose fructose syrup (300.0 g), polydextrose syrup (200 g), and glycerol (80 g) were mixed and heated to 35° C., to form an aqueous phase having a water activity (a_{w}) of 0.71 and a dissolved solids content of 73%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 10 minutes, until the mixture had cooled to 28° C. Powdered chicken flavour (100 g) was then added gradually with mixing. Once all of the powder had been added, mixing was stopped and the bowl edges were scraped to ensure that all particles were fully incorporated.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers.

### Example 8

Pizza flavour emulsion

Palm oil (80.0 g), deodorised cocoa butter (120.0 g), pizza flavour (4.0 g), polyglyceryl polyricinoleate (PGPR) (10.00 g), and distilled monoglycerides (10.00 g) were mixed and heated to 55° C. to form a fat phase. Separately, high maltose glucose syrup (1121.0 g), glucose fructose syrup (250.0 g), polydextrose syrup (300 g), and glycerol (80.0 g) were mixed and heated to 35° C., to form an aqueous phase having a water activity (a_{w}) of 0.73 and a dissolved solids content of 74%.

The fat phase was placed in the bowl of jacketed planetary mixer, which was set to a medium speed. The aqueous phase was then added to the mixer bowl gradually over a one minute period, repeatedly scraping the sides of the bowl to ensure uniformity of the product. Mixing was continued at medium speed for 10 minutes, until the mixture had cooled to 28° C. Tomato powder (20.0 g), and parsley flakes (5.0 g) were then added gradually with mixing. Once all of the particulate ingredients had been added, mixing was stopped and the bowl edges were scraped to ensure that all particles were fully incorporated.

Cooling water from a bath at 20° C. was then circulated through the jacket of the mixing bowl, and mixing was continued for until the temperature of the mixture had reached 24° C. and the mixture became opaque. At this point, both mixing and cooling were halted, and the mixture was given a final stir with a spoon and deposited into sterilised containers,

1. A savoury water-in-oil food emulsion comprising a fat phase and an aqueous phase, wherein the aqueous phase comprises at least 50% dissolved solids.

2. The savoury water-in-oil food emulsion as claimed in claim 1, wherein the dissolved solids comprise bulk sweetener.

3. The savoury water-in-oil food emulsion as claimed in claim 1, wherein the emulsion has a water activity (a_{w}) of less than 0.80.

4. The savoury water-in-oil food emulsion as claimed in claim 3, wherein the aqueous phase comprises a water activity depressant.

5. The savoury water-in-oil food emulsion as claimed in claim 1, wherein the emulsion further comprises a particulate flavouring component.

6. The savoury water-in-oil food emulsion as claimed in claim 5, wherein the particulate flavouring component is distributed throughout the fat phase.

7. The savoury water-in-oil food emulsion as claimed in claim 5, wherein the particulate flavouring material comprises discrete encapsulated regions of flavouring material.

8. The savoury water-in-oil food emulsion as claimed in claim 1, wherein the emulsion comprises at least 0.10% emulsifier.

9. The savoury water-in-oil food emulsion as claimed in claim 8, wherein the emulsion comprises at least 0.60% emulsifier.

10. The savoury water-in-oil food emulsion as claimed in claim 1, wherein the emulsion comprises polyglycerol polyricinoleate (PGPR) and distilled monoglycerides.

11. The savoury water-in-oil food emulsion as claimed in claim 10, wherein the ratio of PGPR to distilled monoglycerides is between 2:1 and 1:2.

12. A food composition comprising an emulsion according to claims 1.

13. The food composition as claimed in claim 12, wherein the food composition is a biscuit composition.

14. A method for preparing a savoury water-in-oil emulsion according to claim 1, comprising providing a first liquid for forming a fat phase, providing a second liquid for forming an aqueous phase, and mixing the first and second liquids to form a water-in-oil emulsion, wherein the second liquid comprises at least 50% dissolved solids.

15. The method as claimed in claim 14, wherein the second liquid has a water activity of less than 0.80.

16. The method as claimed in claim 15, wherein the second liquid comprises a water activity depressant.

17. The method as claimed in claim 14, further comprising adding a particulate flavouring material to at least one of the first liquid, the second liquid, and the water-in-oil emulsion.

18. The method as claimed in claim 17, wherein the method further comprises cooling the emulsion, and the particulate flavouring material is added to the emulsion during or after cooling.

19. The method as claimed in claim 14, wherein the first liquid comprises an emulsifier.

20. The method as claimed in claim 14, wherein the first liquid comprises polyglycerol polyricinoleate (PGPR) and distilled monoglycerides.

21. The method as claimed in claim 14, wherein the temperature of the second liquid on mixing with the first liquid is no more than 50° C.
